(19) United States
(12) Patent Application Publication
(10) Pub. No.: US 2008/0106519 A1
(43) Pub. Date: May 8, 2008

(54) ELECTRONIC DEVICE WITH KEYPAD ASSEMBLY

(76) Inventor: Matthew J. Murray, Raleigh, NC (US)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(21) Appl. No.: 11/555,795

(22) Filed: Nov. 2, 2006

(51) Int. Cl. G06F 3/02; H04M 1/02

(52) U.S. Cl. 345/169; 455/550.1

(57) ABSTRACT

An electronic device includes a keypad assembly. The keypad assembly has a plurality of depressible keys and a touch sensitive pad disposed over at least one of the depressible keys.

### TECHNICAL FIELD OF THE INVENTION

The present invention relates generally to an electronic device, such as a mobile telephone. More particularly, the present invention relates to an electronic device with a user input device in the form of a keypad assembly that combines alphanumeric keys and a multi-directional navigation input device.

### DESCRIPTION OF THE RELATED ART

Mobile and/or wireless electronic devices are becoming increasingly popular. For example, mobile telephones, portable media players and portable gaming devices are now in wide-spread use. In addition, the features associated with certain types of electronic devices are becoming increasingly diverse. To name a few examples, many electronic devices have cameras, text messaging capability, Internet browsing capability, electronic mail capability, video playback capability, audio playback capability, image display capability and handsfree headset interfaces.

In order to use the various features of electronic devices, electronic devices typically include user input devices. For example, many mobile telephones include alphanumeric keys for inputting text data, such as telephone numbers, names, text message bodies, and so forth. The collection of alphanumeric keys conventionally includes twelve buttons. Ten of those buttons are associated with the numbers zero through nine. The buttons for the numbers two through nine also are typically associated with letters of the English alphabet or some other alphabet. The two remaining buttons are typically associated with the star symbol and the pound symbol, respectively. In some other mobile telephones, a larger set of alphanumeric keys may be present. For instance, some mobile telephones have a full QWERTY keyboard where each letter of the English alphabet has an associated key. Some of the QWERTY keys also may be associated with numbers and/or the star and pound symbols, or the numbers and symbols may be associated with additional keys.

Mobile telephones also tend to have dedicated function keys that are associated with a specific task, such as launching a menu, answering a call, ending a call, controlling a camera, and so forth. Some function keys may have multiple uses that depend on an operational mode of the mobile telephone.

In addition, a navigation input device may be present. Navigation devices are often used by the user to input direction so as to navigate through menus, play games, move a cursor, control music or video playback, and so forth. The navigation input device often takes the form of a rocker switch or a dome switch. Conventional navigation input devices allow the user to specify a direction from plural directions for which the navigation input device will accept an input, such as up, down, left and right. Some navigation devices include a ring or plate that may rock in four or more directions to accept corresponding directional inputs. A select button may be present in the center of the ring that, when downwardly depressed, results in the selection of a highlighted menu item or the execution of a function associated with the select button in the current operational mode of the mobile telephone.

Another type of navigation input device is a touch sensitive pad. In some instances, a touch sensitive pad may be arranged as a ring, such as Apple Computer's “Click Wheel” used in ipod media players. The Click Wheel may be used to scroll through menus or play lists by touching the wheel with the tip on one's finger and moving the finger in a clockwise or a counterclockwise direction.

The forgoing collection of buttons and user input devices consumes a considerable amount of space on a surface of the mobile telephone. The presence of alphanumeric keys, function keys and a navigation input device reduces the available space for other items, such as a display, unless the overall size of the mobile telephone is increased.

### SUMMARY

To maximize the available area on an electronic device for a display while providing at least alphanumeric keys and a navigation input device as user input devices, there is a need in the art for a keypad assembly that combines an alphanumeric key(s) and a multi-directional navigation input device. Aspects of the present invention are directed to commingling of one or more alphanumeric keys and a navigation input device such that the alphanumeric keys and the navigation input device overlap on the surface of an electronic device, such as a mobile telephone. In one embodiment, a touch sensitive user input device overlies one or more depressible keys.

According to one aspect of the invention, an electronic device includes a keypad assembly. The keypad assembly has a plurality of depressible keys and a touch sensitive pad disposed over at least one of the depressible keys.

According to an embodiment of the electronic device, the depressible keys are configured for user entry of at least one of alphanumeric characters or function commands, and the touch sensitive pad is configured for user entry of directional input.

According to an embodiment of the electronic device, the touch sensitive pad is configured for user entry of directional input.

According to an embodiment of the electronic device, the touch sensitive pad is configured as a touch sensitive wheel for user entry of directional commands for scrolling through a menu or a play list by clockwise or counterclockwise movement of a finger of the user while touching the touch sensitive pad.

According to an embodiment of the electronic device, the electronic device is configured to play back audiovisual content.

According to an embodiment of the electronic device, a playback command input associated with the touch sensitive wheel is activated by user tapping of the touch sensitive pad.

According to an embodiment of the electronic device, the tapping to activate a playback command input is maintained for at least a specified duration.

According to an embodiment of the electronic device, the touch sensitive pad includes plural touch sensitive segments.

According to an embodiment of the electronic device, the touch sensitive segments are disposed in proximity to one another such that contiguous user movement while touching the pad corresponds to a moving input command.

According to an embodiment of the electronic device, there is a touch sensitive segment for each key over which a portion of the touch sensitive pad is present.

According to an embodiment of the electronic device, the depressible keys are dome keys.

According to an embodiment, the electronic device further includes a control circuit that receives input signals from the keypad assembly, the input signals corresponding to user interaction with the keypad assembly.

According to an embodiment of the electronic device, the control circuit carries out input functions associated with the input signals.

According to an embodiment of the electronic device, the control circuit uses a situational context relating to operation of the electronic device at the time of touching of the touch sensitive pad to interpret an input signal from the touch sensitive pad and carries out a navigational function or a command function corresponding to the interpretation of the input signal.

According to an embodiment of the electronic device, the control circuit uses a time delay to interpret an input signal from the touch sensitive pad and carries out a navigational function or a command function corresponding to the interpretation of the input signal.

According to an embodiment of the electronic device, the keypad assembly further includes user viewable indicia that indicate a function of each depressible key and a function of the touch sensitive pad.

According to an embodiment of the electronic device, an area of touch sensitivity that is associated with the touch sensitive pad is visually indicated by a graphical indicator.

According to an embodiment of the electronic device, the electronic device is a mobile telephone having a radio circuit to establish a call over a communications network.

These and further features of the present invention will be apparent with reference to the following description and attached drawings. In the description and drawings, particular embodiments of the invention have been disclosed in detail as being indicative of some of the ways in which the principles of the invention may be employed, but it is understood that the invention is not limited correspondingly in scope. Rather, the invention includes all changes, modifications and equivalents coming within the spirit and terms of the claims appended hereto.

Features that are described and/or illustrated with respect to one embodiment may be used in the same way or in a similar way in one or more other embodiments and/or in combination with or instead of the features of the other embodiments.

It should be emphasized that the terms “comprises” and “comprising,” when used in this specification, are taken to specify the presence of stated features, integers, steps or components but do not preclude the presence or addition of one or more other features, integers, steps, components or groups thereof.

### BRIEF DESCRIPTION OF THE DRAWINGS

FIG. 1 is a schematic view of a mobile telephone as an exemplary electronic device in accordance with an embodiment of the present invention, the mobile telephone including an exemplary keypad assembly according to the present invention;

FIG. 2 is cross-sectional view of the keypad assembly taken along the line 2-2 of FIG. 1;

FIG. 3 is a schematic block diagram of the relevant portions of the mobile telephone of FIG. 1 in accordance with an embodiment of the present invention;

FIG. 4 is a schematic diagram of a communications system in which the mobile telephone of FIG. 1 may operate; and

FIG. 5 is a flow chart representing an exemplary method of controlling the mobile telephone of FIG. 1 in response to user interaction with the keypad assembly.

### DETAILED DESCRIPTION OF EMBODIMENTS

The present invention will now be described with reference to the drawings, wherein like reference numerals are used to refer to like elements throughout. It will be understood that the figures are not necessarily to scale.

The interchangeable terms “electronic equipment” and “electronic device” include portable radio communication equipment. The term “portable radio communication equipment,” which herein after is referred to as a “mobile radio terminal,” includes all equipment such as mobile telephones, pagers, communicators, electronic organizers, personal digital assistants (PDAs), smartphones, portable communication apparatus or the like.

In the present application, the invention is described primarily in the context of a mobile telephone. However, it will be appreciated that the invention is not intended to be limited to use in a mobile telephone and can be used with any type of appropriate electronic equipment, examples of which include a media player, a gaming device and a computer.

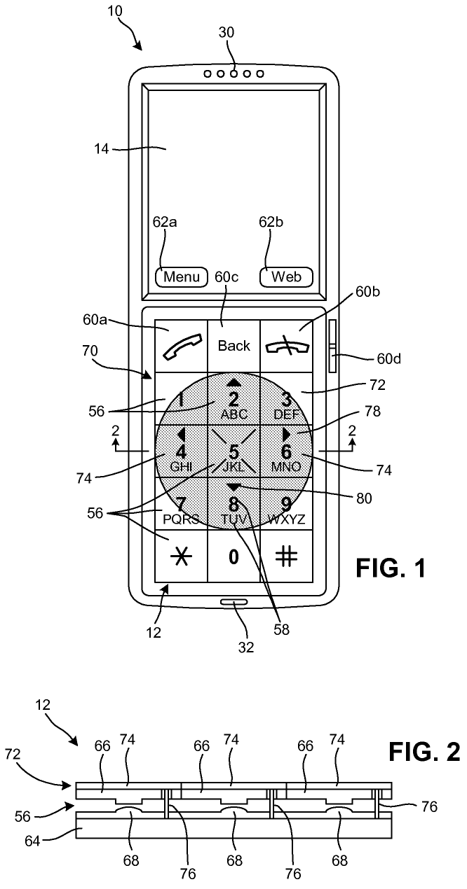

Referring initially to FIGS. 1 through 3, an exemplary electronic device 10 is shown. The electronic device 10 includes a keypad assembly 12. As will be described in greater detail below, the keypad assembly 12 provides for user input of alphanumeric characters and symbols (e.g., the pound and star symbols) as well as user control of the electronic device 10.

The electronic device of the illustrated embodiment is a mobile telephone and will be referred to as the mobile telephone 10. The mobile telephone 10 is shown as having a “brick” or “block” form factor housing, but it will be appreciated that other types of housings, such as a clamshell housing (e.g., a hinged, “flip” open mobile telephone housing) or a slide-type housing, may be utilized.

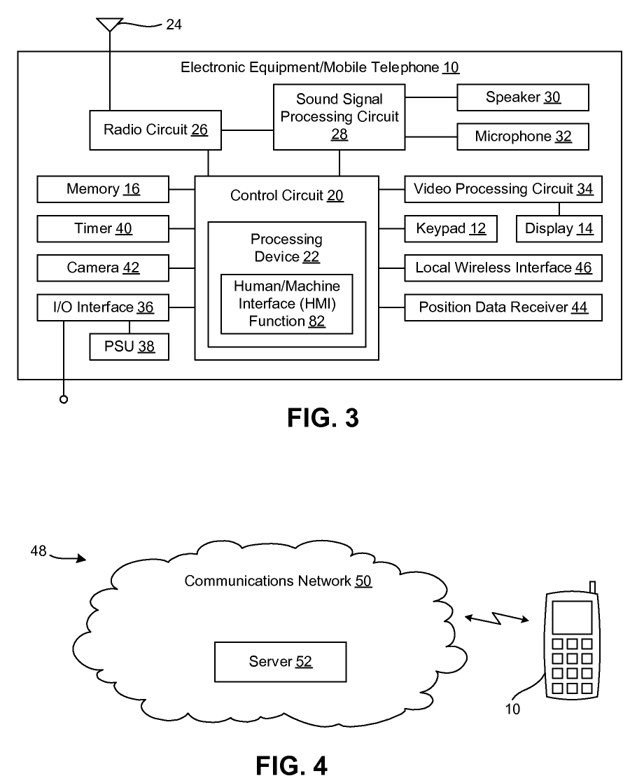

The mobile telephone 10 may include a display 14. The display 14 displays information to a user such as operating state, time, telephone numbers, contact information, various navigational menus, etc., which enable the user to utilize the various features of the mobile telephone 10. The display 14 also may be used to visually display content received by the mobile telephone 10 and/or retrieved from a memory 16 (FIG. 3) of the mobile telephone 10. The display 14 may be used to present images, video and other graphics to the user, such as photographs, mobile television content and video associated with games. In one embodiment, the display 14 may be touch sensitive to allow for user input to be entered by way of applying pressure to the surface of the display 14.

The mobile telephone 10 includes call circuitry that enables the mobile telephone 10 to establish a call and/or exchange signals with a called/calling device, typically another mobile telephone or landline telephone. However, the called/calling device need not be another telephone, but may be some other device such as an Internet web server, content providing server, etc. Calls may take any suitable form. For example, the call could be a conventional call that is established over a cellular circuit-switched network or a voice over Internet Protocol (VOIP) call that is established over a packet-switched capability of a cellular network or over an alternative packet-switched network, such as WiFi, WiMax, etc. Another example includes a video enabled call that is established over a cellular or alternative network.

The mobile telephone 10 may be configured to transmit, receive and/or process data, such as text messages (e.g., colloquially referred to by some as “an SMS”), electronic mail messages, multimedia messages (e.g., colloquially referred to by some as “an MMS”), image files, video files, audio files, ring tones, streaming audio, streaming video, data feeds (including podcasts) and so forth. Processing such data may include storing the data in a memory 16 and/or retrieving the data the memory 16, executing applications to allow user interaction with data, displaying video and/or image content associated with the data, outputting audio sounds associated with the data and so forth.

FIG. 3 represents a functional block diagram of the mobile telephone 10. For the sake of brevity, generally conventional features of the mobile telephone 10 will not be described in great detail herein. The mobile telephone 10 includes a primary control circuit 20 that is configured to carry out overall control of the functions and operations of the mobile telephone 10. The control circuit 20 may include a processing device 22, such as a CPU, microcontroller or microprocessor. The processing device 22 executes code stored in a memory (not shown) within the control circuit 20 and/or in a separate memory, such as memory 16, in order to carry out operation of the mobile telephone 10. The memory 16 may be, for example, one or more of a buffer, a flash memory, a hard drive, a removable media, a volatile memory, a non-volatile memory or other suitable device.

In addition, the processing device 22 may execute code that implements various applications. The applications may carry out functions of the mobile telephone 10 as will be apparent to a person having ordinary skill in the art of computer programming, and specifically in application programming for mobile telephones or other electronic devices. Accordingly, details as to specific applications have been left out for the sake of brevity. Also, while applications are executed by the processing device 22 in accordance with a preferred embodiment of the invention, corresponding functionality could be carried out via dedicated hardware, firmware, software, or combinations thereof.

Continuing to refer to FIGS. 1 and 3, the mobile telephone 10 includes an antenna 24 coupled to a radio circuit 26. The radio circuit 26 includes a radio frequency transmitter and receiver for transmitting and receiving signals via the antenna 24 as is conventional. The radio circuit 26 may be configured to operate in a mobile communications system and may be used to send and receive data and/or audiovisual content. Receiver types for interaction with a mobile radio network and/or broadcasting network include, but are not limited to, GSM, CDMA, WCDMA, GPRS, MBMS, WiFi, WiMax, DVB-H, ISDB-T, etc. as well as advanced versions of these standards.

The mobile telephone 10 further includes a sound signal processing circuit 28 for processing audio signals transmitted by and received from the radio circuit 26. Coupled to the sound processing circuit 28 are a speaker 30 and a microphone 32 that enable a user to listen and speak via the mobile telephone 10 as is conventional. The radio circuit 26 and sound processing circuit 28 are each coupled to the control circuit 20 so as to carry out overall operation. Audio data may be passed from the control circuit 20 to the sound signal processing circuit 28 for playback to the user. The audio data may include, for example, audio data from an audio file stored by the memory 16 and retrieved by the control circuit 20, or received audio data such as in the form of streaming audio data from a mobile radio service. The sound processing circuit 28 may include any appropriate buffers, decoders, amplifiers and so forth.

The display 14 may be coupled to the control circuit 20 by a video processing circuit 34 that converts video data to a video signal used to drive the display 14. The video processing circuit 34 may include any appropriate buffers, decoders, video data processors and so forth. The video data may be generated by the control circuit 20, retrieved from a video file that is stored in the memory 16, derived from an incoming video data stream received by the radio circuit 26 or obtained by any other suitable method.

The mobile telephone 10 further includes one or more I/O interface(s) 36. The I/O interface(s) 36 may be in the form of typical mobile telephone I/O interfaces and may include one or more electrical connectors. As is typical, the I/O interface(s) 36 may be used to couple the mobile telephone 10 to a battery charger to charge a battery of a power supply unit (PSU) 38 within the mobile telephone 10. In addition, or in the alternative, the I/O interface(s) 36 may serve to connect the mobile telephone 10 to a headset assembly (e.g., a personal handsfree (PHF) device) that has a wired interface with the mobile telephone 10. Further, the I/O interface(s) 36 may serve to connect the mobile telephone 10 to a personal computer or other device via a data cable for the exchange of data. The mobile telephone 10 may receive operating power via the I/O interface(s) 36 when connected to a vehicle power adapter or an electricity outlet power adapter.

The mobile telephone 10 may also include a timer 40 for carrying out timing functions. Such functions may include timing the durations of calls, generating the content of time and date stamps, etc. The mobile telephone 10 may include a camera 42 for taking digital pictures and/or movies. Image and/or video files corresponding to the pictures and/or movies may be stored in the memory 16. The mobile telephone 10 also may include a position data receiver 44, such as a global positioning system (GPS) receiver, Galileo satellite system receiver or the like.

The mobile telephone 10 also may include a local wireless interface 46, such as an infrared transceiver and/or an RF adaptor (e.g., a Bluetooth adapter), for establishing communication with an accessory, another mobile radio terminal, a computer or another device. For example, the local wireless interface 46 may operatively couple the mobile telephone 10 to a headset assembly (e.g., a PHF device) in an embodiment where the headset assembly has a corresponding wireless interface.

With additional reference to FIG. 4, the mobile telephone 10 may be configured to operate as part of a communications system 48. The system 48 may include a communications network 50 having a server 52 (or servers) for managing calls placed by and destined to the mobile telephone 10, transmitting data to the mobile telephone 10 and carrying out any other support functions. The server 52 communicates with the mobile telephone 10 via a transmission medium. The transmission medium may be any appropriate device or assembly, including, for example, a communications tower (e.g., a cell tower), another mobile telephone, a wireless access point, a satellite, etc. Portions of the network may include wireless transmission pathways. The network 50 may support the communications activity of multiple mobile telephones 10 and other types of end user devices. As will be appreciated, the server 52 may be configured as a typical computer system used to carry out server functions and may include a processor configured to execute software containing logical instructions that embody the functions of the server 52.

With reference to FIGS. 1 and 2, the keypad assembly 12 will be described in greater detail. The keypad assembly 12 includes plural alphanumeric keys 56 for entering characters, such as numbers, letters and symbols (e.g., a star symbol and/or a pound symbol). In the illustrated embodiment, there are twelve alphanumeric keys 56. The alphanumeric keys 56 are associated with numbers zero through nine and with the star and pound symbols as is common for telephone keypads. The alphanumeric keys 56 associated with the numbers two through nine are also associated with letters from the English alphabet. As will be appreciated, the alphanumeric keys 56 may be associated with characters from other languages and/or other symbols. In other embodiments, there may be less than or more than twelve alphanumeric keys 56. For instance, a complement of alphanumeric keys 56 may be provided to establish a QWERTY keypad.

In the illustrated embodiment, the alphanumeric keys 56 are rectangular. Also, the alphanumeric keys 56 are spaced closely together with minimal or no space between the keys. However, the alphanumeric keys 56 need not be rectangular and may be spaced apart from one another.

Each alphanumeric key 56 may be associated with primary surface indicia 58 (e.g., characters or symbols that are visible by the user). The primary surface indicia 58 corresponds to the alphanumeric character(s) and/or symbols(s) for the alphanumeric key 56. In the illustrated example, the primary surface indicia 58 is disposed in overlying arrangement with the keys 56 so as to be visible by the user. The surface indicia 58 may be printed on the keys 56 or on a touch sensitive member (described below) that covers the keys 56. In other embodiments, the surface indicia 58 may be made from translucent material or opaque material surrounded by translucent material to facilitate backlighting.

The keypad assembly 12 also may include function keys 60. The function keys 60 may correspond to various tasks, such as launching a menu, answering a call, ending a call, controlling a camera, and so forth. Some function keys may have a single specific use and other function keys may have multiple uses that depend on an operational mode of the mobile telephone 10. Also, the function keys 60 may function as soft keys in conjunction with displayed icons, symbols or text shown on the display 14. For instance, in the illustrated embodiment, the function key 60a may serve as a call answer key and as a soft key for displayed indicia 62a (reading “Menu”). Similarly, the function key 60b may serve as a call terminate key and as a soft key for displayed indicia 62b (reading “Web”). Other illustrated function keys 60 include a key 60c labeled “Back” and a volume and/or ringer mute key 60d. In the illustrated embodiment, the keys 60a through 60c are grouped with the alphanumeric keys 56 and have primary surface indicia 58 in the form of icons or text to assist the user in selecting an appropriate key for a desired function.

As best shown in FIG. 2, the alphanumeric keys 56 may be dome foil switches that are mounted on a substrate 64, such as a circuit board. For example, each alphanumeric key 56 may include a downwardly displaceable member 66. The displaceable member 66 may be biased into a rest position using, for example, springs (not shown), levers (not shown) or resiliency of the displaceable member 66. When the user applies downward force to the displaceable member 66, the displaceable member 66 may move toward the substrate 64. As a result of such movement, the underside of the displaceable member may contact and electrically activate a corresponding membrane switch 68 (or other pressure activated device) that forms part of the substrate 64 or that is disposed on the substrate 64. The switches 68 may be coupled though any appropriate circuit to the control circuit 20 (FIG. 3) so that when one of the alphanumeric keys 56 is depressed, a corresponding control signal is input to the control circuit 20. In response, the control circuit 20 may be configured to carry out a corresponding function as described in greater detail below. The function keys 60 that are grouped with the alphanumeric keys 56 may be configured in the same manner as the alphanumeric keys 56.

As indicated, the keypad assembly 12 also includes a navigation input device 70 (also referred to as a direction input device). In the illustrated embodiment, the navigation input device 70 is configured as a touch sensitive region of the keypad 12. The touch sensitive region may be made from a touch sensitive pad 72 that is disposed over one or more of the alphanumeric keys 56 and/or one or more of the function keys 60. The touch sensitive pad 72 may be the aggregate of plural touch sensitive segments 74. In the illustrated embodiment, the touch sensitive pad 72 is made from nine separate segments 74 that respectively overlie the alphanumeric keys 56 labeled with primary surface indicia 58 as keys one through nine. In the cross-sectional view of FIG. 2, three segments 74 of the touch sensitive pad 72 are shown. Each segment 74 may be disposed on the corresponding depressible member 66 and may have leads 76 extending to the substrate 64 through an aperture in the corresponding depressible member 66. Alternatively, the leads 76 may travel between the keys 56. The touch sensitive pad 72 may be coupled via the leads and any appropriate circuit to the control circuit 20 (FIG. 3) so that when the touch sensitive pad 72 is touched by the user, a corresponding control signal is input to the control circuit 20. In response, the control circuit 20 may be configured to carry out a corresponding function as described in greater detail below.

Each segment 74 of the touch sensitive pad 72 may be laterally coextensive with the depressible member 66 upon which the segment 74 is disposed. In the illustrated embodiment, the segments 74 combine to form a touch sensitive region (in this case, a rectangle) that occupies an area of the mobile telephone 10 that overlaps with the area of the mobile telephone 10 occupied by the alphanumeric keys 56. The area occupied by the touch sensitive pad 72 may alternatively overlap with the area occupied by the function keys 60 or may overlap with the area occupied by both the function keys 60 and the alphanumeric keys 56.

Alternatively, each segment 74 may cover only a portion of the depressible member 66 upon which the segment 74 is disposed. In another embodiment, the touch sensitive pad 72 may cover only a portion of one or more keys 56 and/or 60. For instance, the touch pad 72 may be made from arch-shaped segments 74 that partially cover selected keys 56 and/or 60 to form a ring. Additional segments 74 associated with a select function or other command functions also may be present so as to form part of the touch sensitive pad 72. Thus, the segments 74 may be spaced apart from one another and/or may be positioned in close proximity to one another to form a contiguous touch sensitive region.

In still other embodiments, the touch sensitive pad 72 may include a portion that continuously spans over plural keys 56 and/or 60, rather than being made from individual segments 74. A combination of a touch sensitive pad portion that spans plural keys 56 and/or 60 and a touch sensitive pad portion 74 that overlies one key 56 or 60 also may be used. In these embodiments, the touch sensitive pad 72 may be flexible enough to allow individual depression of the keys 56 and/or 60.

The touch sensitive pad 72 may be constructed in any suitable manner. For instance, known pressure, temperature, resistance or capacitance sensing devices may be used in the construction of the touch sensitive pad 72.

A graphical indicator 78 may be used to visually identify to the user where the touch pad 72 is located. In the illustrated embodiment, the graphical indicator 78 is a circle that has a different color than the keys 56 and/or 60 that do not have touch sensitive members disposed thereon and/or portions of the keys 56 and/or 60 that have touch sensitive members disposed thereon but are not marked by the graphical indicator 78. The visual indicator may be made from the touch pad 72 itself or from some other material (e.g., printed indicia), and may or may not be the same shape and/or size as the touch pad 72. In the illustrated example, a round graphical indicator 78 is used to symbolize that the touch pad 72 may be used as a wheel to scroll through menus and/or play lists by moving one's finger in a clockwise or counterclockwise circle while touching the touch pad 72 (e.g., “touch wheel” functionality). It will be appreciated, that the graphical indicator 78 need not be round and may be continuous or non-continuous. For instance, the graphical indicator 78 may have an annular portion to indicate the touch wheel functionality (e.g., a ring overlying the one, two, three, six, nine, eight, seven and four keys 56) and may have a central portion located therein to indicate a center select function (e.g., a dot, arrangement of lines or other symbol overlying the five key 56).

The keypad 12 may be marked with secondary surface indicia 80 to indicate functions associated with the touch sensitive pad 72. In the illustrated embodiment, the secondary surface indicia 80 includes a left arrow on the four key 56, a right arrow on the six key 56, an up arrow on the two key 56, and a down arrow on the eight key 56 to show that the touch sensitive pad 72 may be used to indicate directional input, such as for navigating in a menu and/or a play list, specify cursor movement, specifying movement in a game and so forth. In the illustrated embodiment, lines are shown on the five key 56 to indicate that a select function is associated with the corresponding region of the touch sensitive pad 72. Other secondary surface indicia 80 may be present instead of or in addition to arrow markings. For instance, audiovisual playback symbols (e.g., a stop marking, a play/pause marking, a skip track marking and/or a repeat track marking) may be present. Also, a combination of the secondary surface indicia 80 and the graphical indicator 78 may be used to represent functionality. For instance, the graphical indicator 78 may be annular to illustrate touch wheel functionality and the secondary surface indicia 80 may show touch sensitive functionality associated with the surface area of one or more alphanumeric keys 56.

In one embodiment, the alphanumeric keys 56 and/or the function keys 60 may be backlit. Various backlighting techniques will be known to one of ordinary skill in the art and, therefore, will not be described in detail. For instance, a gap between the keys 56 and/or 60 may be present to allow illumination from a light source to shine around the keys 56 and/or 60. In other embodiments, the keys 56 and/or 60 may be translucent and the surface indicia 58 and/or 80 may be partially or fully opaque. In this case, the graphical indicator 78 and/or the touch sensitive pad 72 also may be translucent or partially translucent. In yet other embodiments, the keys 56 and/or 60 may be opaque and the indicia 58, the indicia 80, the graphical indicator 78 and/or the touch sensitive pad 72 may be partially or fully transparent.

The keypad assembly 12 may be fully or partially “locked” and subsequently “unlocked” to deny or allow entry of characters and commands using the keypad assembly 12. Locking the key assembly 12 reduces the chance of inputting characters and/or carrying out a command by inadvertent contact of the keypad assembly 12. Various combinations of keypad assembly 12 locking functions may be available to the user through menu options and/or specified use of the keypad assembly 12. For instance, locking logic implemented by the control circuit 20 (FIG. 3) may allow the touch sensitive input of the keypad assembly 12 to be locked and the depressible key input of the keypad assembly 12 to be unlocked; may allow the touch sensitive input of the keypad assembly 12 to be unlocked and the depressible key input of the keypad assembly 12 to be locked; and may allow both the touch sensitive input of the keypad assembly 12 and the depressible key input of the keypad assembly 12 to be locked or unlocked.

As will be appreciated, a number of ways of layering navigation control with alphanumeric character entry and/or command entry (e.g., commands associated with function keys 60 and/or soft keys) to conserve space on a surface of the mobile telephone 10 have been described. The reduction in consumed space by the keypad 12 that commingles navigation control with alphanumeric character entry and/or command entry may allow for other components of the mobile telephone 10 to be larger. For instance, the display 14 may be larger in area compared to a comparable display on a comparably sized mobile telephone that has navigation control separated from alphanumeric character entry and/or command entry. Alternatively, the overall size of the mobile telephone 10 may be reduced relative to a mobile telephone that has navigation control separated from alphanumeric character entry and/or command entry.

Referring to FIG. 3, the mobile telephone 10 may store and/or execute a human/machine interface (HMI) function 82 that is configured to interpret signals from the keypad assembly 12 and carry out functions corresponding to user input. The HMI function 82 may be embodied as executable code that is resident in and executed by the mobile telephone 10. In one embodiment, the HMI function 82 may be a program stored on a computer or machine readable medium. For example, the memory 16 may store the HMI function 82 and the processing device 22 may execute code that implements the HMI function 82. It will be apparent to a person having ordinary skill in the art of computer programming, and specifically in application programming for mobile telephones or other electronic devices, how to program a mobile telephone 10 to operate and carry out logical functions associated with the HMI function 82. Accordingly, details as to specific programming code have been left out for the sake of brevity. Also, while the HMI function 82 is executed by the processing device 22 in accordance with a preferred embodiment of the invention, such functionality could also be carried out via dedicated hardware, firmware, software, or combinations thereof, without departing from the scope of the invention. When implemented in software, the HMI function 82 may be a stand-alone software application or form a part of a software application that carries out additional tasks related to the mobile telephone 10.

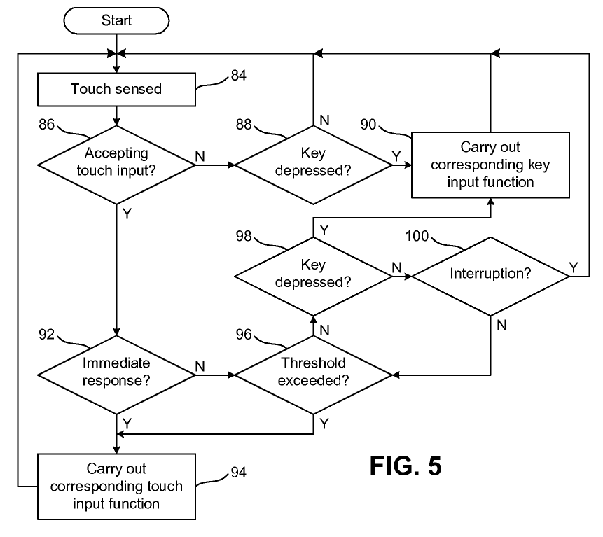

With additional reference to FIG. 5, illustrated are logical operations to implement an exemplary method of operating the mobile telephone 10 in response to user interaction with the keypad assembly 12. The exemplary method may be carried out by executing an embodiment of the HMI function 82, for example. Thus, the flow chart of FIG. 5 may be thought of as depicting steps of a method carried out by the mobile telephone 10. Although FIG. 5 shows a specific order of executing functional logic blocks, the order of executing the blocks may be changed relative to the order shown. Also, two or more blocks shown in succession may be executed concurrently or with partial concurrence. Certain blocks also may be omitted. In addition, any number of functions, logical operations, commands, state variables, semaphores or messages may be added to the logical flow for purposes of enhanced utility, accounting, performance, measurement, troubleshooting, and the like. It is understood that all such variations are within the scope of the present invention.

The illustrated logical flow exemplifies the logical flow that may be followed for a key 56 or 60 that has a portion of the pad 72 overlying the key 56 or 60. The logical flow may not apply to keys 56 and/or 60 that are not associated with a portion of the pad 72.

As will be appreciated, the sensing and determining described in connection with the following exemplary logical flow may be based on signals that the control circuit 20 receives from the keypad assembly 12.

It is noted that a depression of a key 56 or 60 that underlies a portion of the pad 72 may include touching of the pad 72. Thus, the detection of touch input slightly before or commensurate with the detection of a key depression may occur. The logic flow for the HMI function 82 may use situational contexts (e.g., an operating mode of the mobile telephone 10) and/or time delays to distinguish between use of the pad 72 and intended key depression.

The logical flow for the HMI function 82 may begin in block 84 where touching of the touch sensitive pad 72 is sensed (e.g., detected). As indicated, at this stage in the logical flow, it may be assumed that it is unknown whether the detection of touching of the pad 72 is associated with the user touching the pad 72 to activate a touch-based input or with the user initiating a key 56 or 60 depression. Proceeding to block 86, a determination may be made as to whether the mobile telephone 86 is accepting input from the pad 72. A negative determination may be made in block 86 if the pad 72 has been locked by user action or is otherwise turned off. Also, a negative determination may be made in block 86 if the operational mode of the mobile telephone 10 and/or the situational context for how the mobile telephone 10 is being used indicates that user input should be accepted by depression of one or more alphanumeric keys 56 and/or function keys 60, but not by touching of the pad 72. For instance, if a telephone number or text is being entered into the mobile telephone 10 for the dialing of a telephone number, the population of a contact list entry, the generation of a text or electronic mail message, or the like, the manner in which the mobile telephone 10 is being used may indicate that key depression input is to be expected rather than touch input.

Upon a negative determination in block 86, the logic flow may proceed to block 88 where a determination may be made as to whether a key 56 and/or 60 has been depressed. If a key 56 and/or 60 has not been depressed, the logical flow may return to block 84 to await touching of the pad 72. If a positive determination is made in block 88, the logical flow may proceed to block 90 where an input function corresponding to the depressed key may be carried out. For instance, entry of an alphanumeric character corresponding to the depression of one of the alphanumeric keys 56 may be made or performance of a task corresponding to the depression of one of the function keys 60 may be made, as is appropriate for the depressed key 56 or 60. Thereafter, the logical flow may return to block 84 to await touching of the pad 72.

If a positive determination is made in block 86, the logical flow may proceed to block 92. In block 92, a determination may be made as to whether an immediate response to the touching of the pad 72 is appropriate. An immediate response may be appropriate depending on the situational context in which the mobile telephone 10 is actively being used. For instance, if the mobile telephone 10 is being used in an audiovisual content playback mode, the pad 72 may be used as a touch wheel to navigate through a play list and/or may be used to control playback by touching (e.g., tapping) an area dedicated to a playback function, such as stopping playback, starting and/or pausing playback, skipping a track or repeating a track.

In other embodiments, the determination of block 92 may be based on the portion of the pad 72 that has been touched. For instance, if the pad is touched over an alphanumeric key 56 that has no functionality in the situational context, the user input may assumed to be touch related and a positive determination may be made in block 92. In other situations, a duration since a last touch may be tracked to detect a touch sequence that has an associated input function, such as a double tapping of the pad 72 that could be used to indicate a select function or a command equivalent to a “double click” of a computer mouse.

Following a positive determination in block 92, the logical flow may proceed to block 94. In block 94, a function corresponding to the touching action may be carried out. This typically may be the performance of a task corresponding to the touched portion of the pad 72. For example, if the user touches (e.g., taps) a spot on the pad 72 corresponding to a directional input, a cursor or game character may be moved in the specified direction or a menu may scroll in the specified direction. In another example, if the user touches a spot on the pad 72 and moves his or her finger across the pad 72, a corresponding movement motion may be carried out, such as scrolling through a menu or a play list for a clockwise or counterclockwise motion (e.g., touch wheel functionality). Also, a touching input associated with a motion may be used to move a mouse pointer shown on the display 14 in correspondence with the sensed input motion. As will be appreciated, other movement-based and nonmovement-based user input may be associated with touching of the pad 12. Following block 94, the logical flow may return to block 84 to await touching of the pad 72.

If a negative determination is made in block 92, the logical flow may proceed to block 96. In block 96, a determination may be made as to whether a time delay threshold has been exceeded. The time delay threshold may be used to distinguish the touching of the pad 92 for purposes of entering a touch-based input from the initiation of depressing a key 56 or 60. The time delay threshold may be about an eighth of a second to about a second in duration, although longer or shorter time delay thresholds are contemplated. If the threshold is exceeded, it may be determined that the user intended to invoke a touch-based entry and the logical flow may proceed to block 94 to carry out an input function in accordance with the detected touch.

If a negative determination is made in block 96, the logical flow may proceed to block 98. In block 98 a determination may be made as to whether the user has activated one of the alphanumeric keys 56 or one of the function keys 60 (e.g., by depressing the key 56 or 60). If such a keystroke has been made (e.g., a positive determination in block 98), the logical flow may proceed to block 90 to carry out an input function in accordance with the detected keystroke.

If a negative determination is made in block 98, the logical flow may proceed to block 100. In block 100, a determination may be made as to whether touching of the pad 72 has been interrupted, such as by the user lifting his or her finger off of the pad 72. If an interruption has been detected, the logical flow may return to block 84 to await touching of the pad 72. If no interruption has been detected, the logical flow may return to block 96 to continue to assess the touching of the pad 72 as described above.

The exemplary keypad 12 embodiments and exemplary methods of operation described herein set forth a manner in which a touch sensitive user input device and a force sensitive user input device (e.g., depression keys) may be combined in the same or overlapping area of an electronic device. In the illustrated embodiments, one or more touch sensitive members are placed on top of dome-foil keys. Adjacent touch sensitive areas may be made continuously with one another or may be placed close enough together such that contiguous user movement while touching the touch sensitive areas may be used for scrolling or other user input function (e.g., to specify motion that may be monitored as a function of direction, speed and/or duration).

Although the invention has been shown and described with respect to certain preferred embodiments, it is understood that equivalents and modifications will occur to others skilled in the art upon the reading and understanding of the specification. The present invention includes all such equivalents and modifications, and is limited only by the scope of the following claims.

What is claimed is:

1. An electronic device comprising a keypad assembly that includes:
a plurality of depressible keys; and
a touch sensitive pad disposed over at least one of the depressible keys.

2. The electronic device of claim 1, wherein the depressible keys are configured for user entry of at least one of alphanumeric characters or function commands, and the touch sensitive pad is configured for user entry of directional input.

3. The electronic device of claim 1, wherein the touch sensitive pad is configured for user entry of directional input.

4. The electronic device of claim 1, wherein the touch sensitive pad is configured as a touch sensitive wheel for user entry of directional commands for scrolling through a menu or a play list by clockwise or counterclockwise movement of a finger of the user while touching the touch sensitive pad.

5. The electronic device of claim 4, wherein the electronic device is configured to play back audiovisual content.

6. The electronic device of claim 4, wherein a playback command input associated with the touch sensitive wheel is activated by user tapping of the touch sensitive pad.

7. The electronic device of claim 6, wherein the tapping to activate a playback command input is maintained for at least a specified duration.

8. The electronic device of claim 1, wherein the touch sensitive pad includes plural touch sensitive segments.

9. The electronic device of claim 8, wherein the touch sensitive segments are disposed in proximity to one another such that contiguous user movement while touching the pad corresponds to a moving input command.

10. The electronic device of claim 8, wherein there is a touch sensitive segment for each key over which a portion of the touch sensitive pad is present.

11. The electronic device of claim 1, wherein the depressible keys are dome keys.

12. The electronic device of claim 1, further comprising a control circuit that receives input signals from the keypad assembly, the input signals corresponding to user interaction with the keypad assembly.

13. The electronic device of claim 12, wherein the control circuit carries out input functions associated with the input signals.

14. The electronic device of claim 13, wherein the control circuit uses a situational context relating to operation of the electronic device at the time of touching of the touch sensitive pad to interpret an input signal from the touch sensitive pad and carries out a navigational function or a command function corresponding to the interpretation of the input signal.

15. The electronic device of claim 13, wherein the control circuit uses a time delay to interpret an input signal from the touch sensitive pad and carries out a navigational function or a command function corresponding to the interpretation of the input signal.

16. The electronic device of claim 1, wherein the keypad assembly further includes user viewable indicia that indicate a function of each depressible key and a function of the touch sensitive pad.

17. The electronic device of claim 1, wherein an area of touch sensitivity that is associated with the touch sensitive pad is visually indicated by a graphical indicator.

18. The electronic device of claim 1, wherein the electronic device is a mobile telephone having a radio circuit to establish a call over a communications network.
